(19) United States
(12) Patent Application Publication
(10) Pub. No.: US 2016/0288135 A1
(43) Pub. Date: Oct. 6, 2016

(54) CLOSED-CIRCUIT GRINDING PLANT HAVING A PRE-CLASSIFIER AND A BALL MILL

(71) Applicant: KHD Humboldt Wedag GmbH

(72) Inventor: Joerg Binner, Engelskirchen (DE)

(21) Appl. No.: 15/103,167

(22) PCT Filed: Dec. 9, 2014
(86) PCT No.: PCT/EP2014/076964

§ 371 Date: Jun. 9, 2016

(30) Foreign Application Priority Data
Dec. 11, 2013 (DE) 102013020888.2

(51) Int. Cl. B02C 23/14; B02C 23/12; B02C 21/00

(52) U.S. Cl. CPC B02C 23/14; B02C 21/005; B02C 23/12

(57) ABSTRACT

A closed-circuit grinding plant for grinding fresh material, comprising a first device for grinding the fresh material, a static pre-classifier preclassifying the ground material, having an input for the ground material, an output for a coarse meal fraction, and a further output for a fine-grained output material. A device separates out fine material, having an output for a coarse-grained fraction, with subsequent recirculation to the first grinding device, an output for fine material, and at least one input. The input is connected to the static pre-classifier output. A second grinding device is also provided. The static pre-classifier is a cascade classifier and the second grinding device is a ball mill The ball mill has a material inlet connected to the output opening for the coarse meal fraction of the cascade classifier and a material outlet connected to an input opening of the device for separating out fine material.

### CROSS-REFERENCES TO RELATED APPLICATIONS

This application claims the benefit of the German patent application No. 10 2013 020 888.2 filed on Dec. 11, 2013, the entire disclosures of which are incorporated herein by way of reference.

### BACKGROUND OF THE INVENTION

The invention relates to a closed-circuit grinding plant for grinding fresh material, having a first device for grinding the fresh material, wherein the first device for grinding the fresh material produces ground material for grinding, a static pre-classifier for pre-classifying the ground material for grinding, having an input opening for the ground material for grinding, having an output opening for a classified-out coarse grit fraction, and having a further output opening for the output of a fine-grain output material, a device for classifying out fine material, having an output opening for the output of a separated-out coarse grain fraction, with subsequent recirculation to the first device for grinding the fresh material, having an output opening for the classified-out fine material, and having at least one input opening, wherein one of the at least one input opening is connected to the output opening for the fine-grain output material of the static pre-classifier, a second device for grinding material for grinding, wherein the second device for grinding material for grinding produces a ground material for grinding.

To obtain granular fine material from fresh material provided as coarse material, the fresh material is fed into a device for grinding material for grinding. To achieve a high degree of grinding fineness, it is known for the material for grinding to be circulated in the process of a closed-circuit grinding plant until, as a result of sufficient comminution, it is removed from the circuit by classification. A primary example is the production of cement and/or raw cement meal by the grinding of cement clinkers, blast furnace slag or slag sand, limestone and/or gypsum. For the comminution of the fresh material, use is made, in particular, of roller presses which, correspondingly to their mode of operation, are also referred to as “high-pressure roll press,” “high-compression roll mill” or “high pressure grinding roller press” (HPGR). The ground material for grinding from the device for grinding the fresh material is generally composed of coarse material that is still present and of a more fine-grain fraction. To obtain the fine material, the ground material for grinding is separated from the coarse material in a classifying-out device and is separated off. For the separation of granular solid material in fractions of different grain size, the use of dynamic classifiers, in particular rod-cage classifiers, is known in the case of cement production. Also known are two-stage methods in which a static pre-classifier, for example a cascade classifier, is positioned upstream of the dynamic classifier. This not only reduces the wear of the dynamic classifier. Furthermore, in the cascade classifier, material agglomerates that form in roller presses and other grinding devices are also deagglomerated.

DE 102 21 739 A1 has disclosed a closed-circuit grinding plant in which the ground material for grinding from a high-pressure roll mill or roller press is supplied to a cascade classifier arranged therebelow. A further classifier, for example a dynamic rod-cage classifier, is positioned downstream of the cascade classifier, to which rod-cage classifier the classified material output from the cascade classifier is pneumatically supplied, which, as a result of mechanical delivery devices being dispensed with, leads to lower operating and investment costs and a smaller space requirement. The post-classifier is arranged above the roller press into which the coarse material output is recirculated. For the further treatment of the coarse material separated off in the cascade classifier, two possibilities are proposed: either the fraction is supplied to the roller press again, or an impact comminution means is integrated in the lower part of the cascade classifier, which impact comminution means, by way of a rotor, centrifuges the material back upward into the cascade classifier. The disadvantage of the latter approach is however that, here, only the deagglomeration process is improved by way of multiple passes through the cascade classifier. The impact action is not sufficient for further comminution of non-agglomerated components in the coarse grain fraction. A recirculation of the fraction into the roller press, which must be performed in accordance with the first approach, requires not only purely mechanical and thus energy-intensive and expensive transport. Also known are ventilation and material pressing difficulties in the roll gap of roll or roller presses if, in this case, relatively small-grain material, such as is present in the output of the cascade classifier, is fed in in addition to the fresh material. Furthermore, the grinding of cement clinker using roller presses to form a small fine material fraction with particularly fine particle size consequently leads to a steep grain size distribution curve. In the case of cement production, the grain size distribution co-determines the strength of the cement building material. Owing to a then very compact arrangement of the fine material particles, it is possible to realize a particularly high strength of cement if the fine cement material is provided as a mixture composed of a fine material fraction of extremely small grains and a fine material fraction composed of relatively large grains. Consequently, what is desirable is a broader grain size distribution than that realized with the grain size distribution curve of a roller press.

It may therefore be advantageous for a further device for grinding material for grinding to be incorporated into the closed-circuit grinding plant, for example a ball mill (tube mill, tube ball mill) DE 10 2006 017 510 A1 describes a closed-circuit grinding plant having a first grinding assembly, for example a roller press, for the pre-grinding of fresh material, having a dynamic classifier, and having a tube mill Here, a cascade classifier may be positioned upstream of the dynamic classifier. A division into two grinding circuits is provided, which are coupled by way of the dynamic rod-cage classifier, which is formed with two chambers. Arranged in the first grinding circuit are the first grinding assembly (roller press) and, if present, the static pre-classifier, and in the second grinding circuit, the tube mill is provided. The tube mill is used exclusively for the grinding of the fine grit output from the dynamic classifier. Since the coarse grit output from the rod-cage classifier is recirculated to the roller press, the use of a tube mill does not lead to a cost-effective reduction of the number of passes through the first circuit. Although not described in any more detail, it is also to be assumed that the separated-off coarse fraction from the pre-classifier should either be fed to the roller press again, which would lead to the disadvantages are already mentioned above, or else would be discharged from the circuit entirely, to the detriment of the efficiency of the process. The advanced technology of the multi-chamber classifier required here is furthermore, in practice, associated with higher investment and maintenance costs than simple rod-cage classifiers.

DE 39 05 123 A1 describes a closed-circuit grinding plant with high-compression comminution roll press, tube mill and classifier with separate recirculation of the classifier grit fractions. Here, the output from the roll press is supplied (via a pre-comminution device that may be provided) to the tube mill without pre-classification. Here, the tube mill has a deagglomeration chamber. It is a disadvantage here that the deagglomeration process in the ball mill is very time-consuming In particular, however, a fraction of relatively coarse, non-ground particles remains there, the grain size of which is not based on agglomeration. The particles, owing to their size, have such a high weight that they are not amenable to pneumatic transport from the ball mill into the classifier. The fraction would have to be removed separately from the deagglomeration chamber and supplied mechanically, that is to say in a manner which entails additional costs (for example by way of a bucket conveyor) to the classifier (or to the roll press again).

DE 33 02 176 A1 discloses an exemplary embodiment of a comminution system, in which material ground in a roll machine is supplied to a classifying screen. The relatively coarse fraction classified out is conducted into a tube mill, whereas the relatively fine fraction is supplied to a classifier into which the material output from the tube mill also passes. The coarse grit fraction of the classifier can be recirculated, in the grinding circuit, to the roll machine or to the tube mill It is however a disadvantage that, without being subject to rapid wear, a classifying screen exerts no deagglomeration action, or only an insufficient deagglomeration action, on the material agglomerates or scabs of the ground material emerging from the roll press. Furthermore, the classifying screens suitable in particular for the required high throughput rates do not sort out only a purely fine material fraction, but merely separate a fine and medium material fraction from a coarse material fraction, which has an adverse effect on the efficiency of the classifying process in the downstream classifier and on the grain size distribution of the final product, and/or necessitates economically adverse additional measures.

### SUMMARY OF THE INVENTION

It is therefore an object of the invention to provide a closed-circuit grinding plant for grinding fresh material, which closed-circuit grinding plant overcomes the disadvantages from the prior art.

It is provided according to the invention that, as static pre-classifier, use is made of a static cascade classifier. Provision is also made whereby, as a second device for grinding material for grinding, a ball mill is incorporated into the closed-circuit grinding plant for grinding fresh material, in such a way that, firstly, the material inlet of the ball mill is connected to the output opening for the classified-out coarse grit fraction of the static pre-classifier. The coarse-grain fraction that is separated off during the pre-classifying is consequently supplied to the ball mill for further grinding. For advantageous material transport, it is obvious for the ball mill to be arranged below the pre-classifier. Secondly, the material outlet of the ball mill is connected to an input opening of the device for classifying out fine material, such that the fine material fraction is classified out from the ground output material from the ball mill.

According to the invention, a closed-circuit grinding plant is thus provided in which fresh material is ground in a first device for grinding, wherein the resulting ground material for grinding is, in a static pre-classifier, separated into a fine-grain fraction and a relatively coarse-grain fraction. The fine-grain fraction may be supplied pneumatically, that is to say, in a manner which is expedient in terms of energy and costs, to the device for classifying out fine material. The relatively coarse grit fraction is firstly ground in the ball mill and then likewise passes, as ground output material, into the classifier, where a fine material fraction is separated off and a coarse grain fraction is output and recirculated to the first device for grinding. This construction, in which a division of the grinding circuit into two sub-circuits is thus provided, offers numerous advantages. With the cascade classifier as a static pre-classifier, a classifier type is used which not only pre-classifies the ground material for grinding from the first device for grinding but also already deagglomerates the ground material for grinding, whereby the need for deagglomeration processes in the ball mill (with the disadvantages described above) is omitted. The grit fraction from the static pre-classifier furthermore does not need to be mechanically delivered back to the first device for grinding (with the disadvantages likewise described above), but rather is ground in the ball mill Here, ground output material is produced which can entirely be delivered pneumatically and which, together with the fine material fraction, which is to be classified out, from the first device for grinding fresh material, leads to an expedient grain size distribution of the cement or raw cement meal. Furthermore, the grinding of the grit fraction from the static pre-classifier in the ball mill in the second sub-circuit leads to a reduction of the number of passes through the first sub-circuit. Also, the use of a static pre-classifier between the two devices for grinding reduces the volume of material input into the ball mill, as a result of the classifying-out of the fine-grain output material in the static pre-classifier.

According to the invention, it is provided that the static pre-classifier is a cascade classifier. Cascade classifiers permit not only a separation of coarse-grain and relatively fine-grain fractions in the ground material for grinding. Furthermore, as a result of the impacting action of the material particles introduced into them against the plates arranged in cascaded fashion in the classifying shaft thereof, the cascade classifiers also contribute significantly to a deagglomeration of agglomerated particles of material for grinding, such as form in devices for grinding material for grinding, in particular in roller presses or high-pressure roll presses.

In a refinement of the invention, provision is made for a rod-cage classifier to be used as a device for classifying out fine material. Such a dynamic classifier type is well known from practice, requires little maintenance and can be subjected to a pneumatic flow for the introduction of material, which is expedient in terms of energy and costs. Both the classifying process in the static pre-classifier and the grinding process in the ball mill lead to such fine-grain, that is to say light output material that this can, in a refinement of the invention, be in each case suspended in a classifying air volume flow and supplied pneumatically to the rod-cage classifier. Depending on the type of construction of the classifier, the classifying air volume flows pass through the same input opening or through two different input openings into the housing of the rod-cage classifier for common classification. The fine material that is classified out is captured in an output device of the rod-cage classifier and is supplied pneumatically to a separating device, where the fine material is separated from the classifying air. The pneumatic transport of the ground output material from the ball mill offers considerable advantages in relation to mechanical transport with regard to energy expenditure, investment costs and maintenance costs. If it is unavoidable owing to the overall construction of a plant for cement production, it would also be possible for a first part of the path from the ball mill to the rod-cage classifier to be bridged by way of a mechanical device, for example a bucket conveyor.

In a particular refinement of the invention, as a first device for grinding the fresh material, use is made of a roller press, a vertical mill or an impact hammer mill Here, the invention is not restricted to one type of grinding device; rather, it may be expedient, in accordance with the desired grain distribution sizes of the cement and in a manner dependent on the condition of the fresh material, to use different grinding devices. With regard to energy costs, efficiency and material throughput and operational simplicity, the use of roller presses and of vertical mills in particular is obvious. Impact hammer mills also have advantages over ball mills with regard to energy.

### BRIEF DESCRIPTION OF THE DRAWINGS

The invention will be discussed in more detail on the basis of the following figures, in which:

FIG. 1 shows a closed-circuit grinding plant according to the invention for grinding fresh material, in the exemplary embodiment with a roller press, ball mill, cascade classifier and, illustrated in vertical section, rod-cage classifier;

FIG. 2a shows a detail of the closed-circuit grinding plant according to the invention for grinding fresh material, illustrating the exemplary embodiment with an impact hammer mill as a first device for grinding the fresh material;

FIG. 2b shows a detail of the closed-circuit grinding plant according to the invention for grinding fresh material, illustrating the exemplary embodiment with a vertical mill as the first device for grinding the fresh material.

### DETAILED DESCRIPTION OF THE PREFERRED EMBODIMENTS

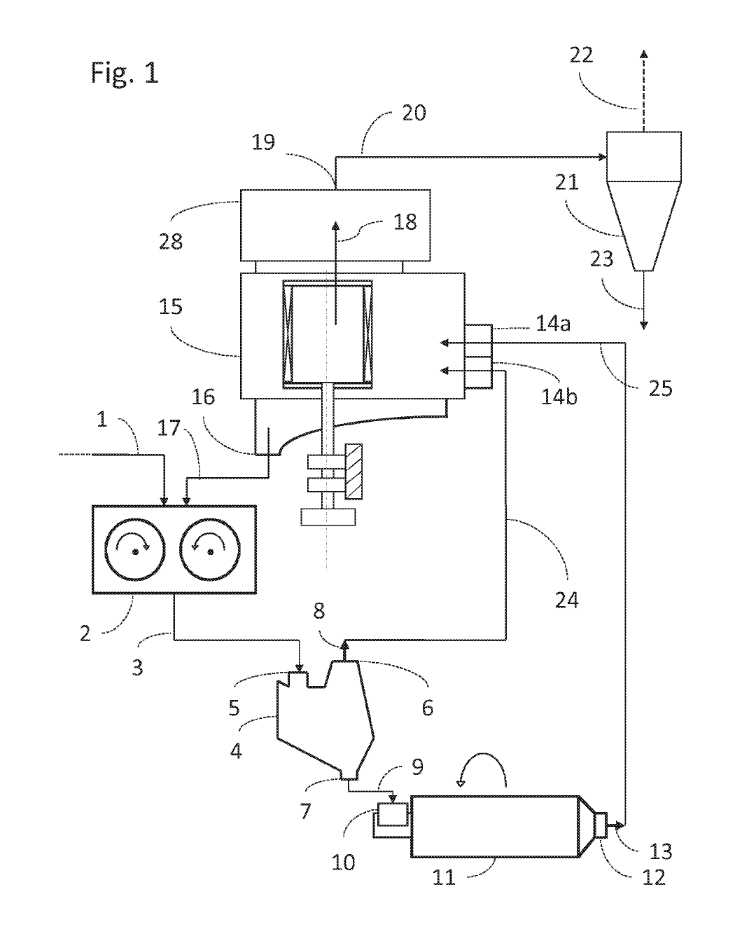

In FIG. 1, the closed-circuit grinding plant has a roller press 2 as a first device (2, 26, 27) for grinding fresh material which is supplied via the fresh material supply 1. The ground material for grinding 3 is fed mechanically, from above, into a static pre-classifier, the cascade classifier 4, which is arranged below the roller press 2. By way of classifying air which is supplied separately and transversely with respect thereto, a separation of a fine-grain fraction and of a relatively coarse-grain fraction is realized in the cascade classifier 4 by virtue of the fine material being classified out in the air flow and being output, as fine-grain output material 8, upward through the output opening 6. (The processes in the interior of the cascade classifier 4 are not shown.) The fine-grain output material 8 is supplied pneumatically with the classifying air volume flow 24 to the rod-cage classifier 15. Furthermore, in the cascade classifier 4, the coarse-grain fraction falls downward under inclined guide plates arranged in cascaded fashion. As a result of the impacting of the coarse-grain scab material against the plates, the material agglomerates situated therein are deagglomerated and are output, as grit fraction 9, downwardly out of the cascade classifier 4 through the output opening 7. The grit fraction 9 falls into the material inlet 10 of a ball mill 11 arranged below the cascade classifier 4. The ground output material 13 exits the ball mill 11 through the material outlet 12. The ground output material is supplied pneumatically to the rod-cage classifier 15 by way of the classifying air volume flow 25. Here, it would be possible for initially mechanical transport of the ground output material 13 to be realized, for example by way of a bucket conveyor (not shown), on the path between ball mill 11 and rod-cage classifier 15.

The classifying air volume flows 24, 25 with the fine-grain output material 8 from the cascade classifier 4 and with the ground output material 13 from the ball mill 11 are introduced into the rod-cage classifier 15 through at least one input opening 14a, 14b. The output material 8, 13 suspended in the classifying air flows laterally to the rod-cage classifier 15, as illustrated, and is, owing to the rotational movement of the rod-cage classifier 15, accelerated into the classifying zone thereof. The centrifugal forces acting on the particles of the material for classification lead, in interaction with the friction force of the air flow, to a separation of the material for classification into a coarse grain fraction 17 and a fraction of fine material 18. The coarse grain fraction 17 is output from the rod-cage classifier 15 downwardly out of the classifying zone and through the output opening 16 under the action of gravitational force. Subsequently, the coarse grain fraction 17 is conducted back (recirculation) to the roller press 2 from above by mechanical means, at which roller press the coarse grain fraction is ground together with the fresh material from the fresh material supply 1. The classified-out fine material 18 is transported pneumatically out of the rod-cage classifier 15 by the classifying air flow and passes into the output device 28. Through the outlet opening 19, the classifying air flow 20 with the fine material exits the output device 28 and passes to the separating device (in this case a cyclone) 21. In the separating device 21, the fine material 23 is separated from the classifying air flow 22 and can thus, in the further process of cement production, be stored in silos (not shown in the figure).

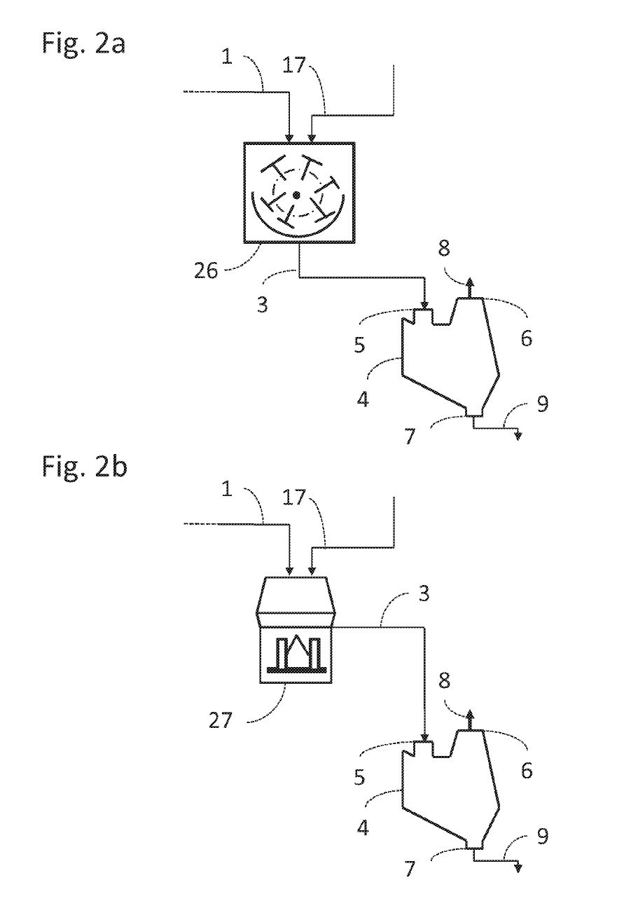

FIG. 2a shows a detail of the closed-circuit grinding plant according to the invention for grinding fresh material. In the exemplary embodiment shown, the first device (2, 26, 27) for grinding the fresh material is formed not by a roller press 2, as in FIG. 1, but by an impact hammer mill 26. Otherwise, the construction and process are the same as illustrated in FIG. 1.

In the same way, FIG. 2b illustrates a detail of the closed-circuit grinding plant according to the invention for grinding fresh material. In the exemplary embodiment shown, the first device (2, 26, 27) for grinding the fresh material is formed not by a roller press 2, as in FIG. 1, or by an impact hammer mill 26, as in FIG. 2a, but by a vertical mill 27. Otherwise, the construction and process are the same as illustrated in FIG. 1.

As is apparent from the foregoing specification, the invention is susceptible of being embodied with various alterations and modifications which may differ particularly from those that have been described in the preceding specification and description. It should be understood that I wish to embody within the scope of the patent warranted hereon all such modifications as reasonably and properly come within the scope of my contribution to the art.

### LIST OF REFERENCE DESIGNATIONS

1 Fresh material supply
2 Roller press
3 Ground material for grinding
4 Cascade classifier
5 Input opening
6 Output opening
7 Output opening
8 Fine-grain output material
9 Grit fraction
10 Material inlet
11 Ball mill
12 Material outlet
13 Ground output material
14a, 14b Input opening
15 Rod-cage classifier
16 Output opening
17 Coarse grain fraction
18 Fine material
19 Output opening
20 Classifying air flow with fine material
21 Separation device
22 Classifying air
23 Fine material
24 Classifying air volume flow
25 Classifying air volume flow
26 Impact hammer mill
27 Vertical mill
28 Output device

1-4. (canceled)

5. A closed-circuit grinding plant for grinding fresh material, comprising:
a first device for grinding the fresh material, wherein the first device for grinding the fresh material produces ground material for grinding,
a static pre-classifier configured to classify the ground material, having an input opening for the ground material, having an output opening for a classified-out coarse grit fraction, and having a further output opening for the output of a fine-grain output material,
a device configured to classify out fine material, having an output opening for the output of a separated-out coarse grain fraction, with subsequent recirculation to the first device for grinding the fresh material, having an output opening for the classified-out fine material, and having at least one input opening, wherein
one of the at least one input opening is connected to the output opening for the fine-grain output material of the static pre-classifier,
a second device for grinding material, wherein
the second device for grinding material produces a ground output material,
the static pre-classifier is a cascade classifier, and
the second device for grinding material for grinding is provided in the form of a ball mill, wherein the ball mill comprises
a material inlet which is connected to the output opening for the classified-out coarse grit fraction of the cascade classifier, and
a material outlet, which is connected to the at least one input opening of the device for classifying out fine material, for the ground output material.

6. The plant as claimed in claim 5, wherein the device for classifying out fine material is a rod-cage classifier.

7. The plant as claimed in claim 6, wherein
a pneumatic supply of the fine-grain output material from the cascade classifier into one of the at least one input opening of the rod-cage classifier and
a pneumatic supply of the ground output material from the ball mill into one of the at least one input opening of the rod-cage classifier
is provided by way of, in each case, one classifying air volume flow.

8. The plant as claimed in claim 5, wherein the first device for grinding the fresh material is an impact hammer mill.

9. The plant as claimed in claim 5, wherein the first device for grinding the fresh material is a roller press.

10. The plant as claimed in claim 5, wherein the first device for grinding the fresh material is a vertical mill.
